(19) United States
(12) Patent Application Publication
(10) Pub. No.: US 2022/0061267 A1
(43) Pub. Date: Mar. 3, 2022

(54) Metal Door Hanging Cat Toy

(71) Applicant: Mark Richard Prokop, Nampa, ID (US)

(72) Inventor: Mark Richard Prokop, Nampa, ID (US)

(21) Appl. No.: 16/947,952

(22) Filed: Aug. 25, 2020

(51) Int. Cl. A01K 15/02; E06B 7/28

(52) U.S. Cl. CPC A01K 15/025; E06B 7/28

(57) ABSTRACT

Metal flexible cat toy designed to hang over the top of doors, probably, closet doors. It is made out of flat sheet metal—16 gauge and bent in a unique way. This allows for the flexibility necessary for the toy hanging from an elastic cord, possibly a stuffed mouse, cricket or lizard to bounce around and to allow the cat to grab the stuffed toy with its claws or teeth and pull it. This cord is attached to the metal hanging off of the top of the closet door. The flexible metal and the elastic cord allow the stuffed toy to bounce around and to swing giving the cat a moving target to jump at, grab and bit.

### CROSS-REFERENCE TO RELATED APPLICATIONS

Design Patent #29/734,695, Date Filed Jun. 26, 2020, Confirmation #7641, Group Art Unit #2913

### STATEMENT REGARDING PRIOR DISCLOSURES BY THE INVENTOR OR A JOINT INVENTOR

I created two prototypes and gave one to a Beta Tester on Feb. 3, 2020 who has been testing my invention ever since.

### BACKGROUND OF THE INVENTION

(1) Field of the Invention: The present application relates to a Metal Door Hanging Cat Toy that will hang over the top of, probably, a hall closet door in a home giving a cat or cats something to occupy their time and allow for more physical activity/exercise.

(2) Background: I have searched for other similar devices both online and on the USPTO web site, and other cat toys that hang from doors are made of cheap plastic, and reviews given by consumers say that they break within a short period of time after their cat or cats start playing with them. My invention has been beta tested by an individual who has a young, energetic and very physically active cat who has been using my invention daily for over six months now, and my invention is still intact and no part of it has broken or snapped.

(3) Description of Related Art including information disclosed under 37 CFR 1.97 and 1.98

### BRIEF SUMMARY OF THE INVENTION

This application is for a Metal Door Hanging Cat Toy made out of 16-gauge sheet metal cut into a rectangle 1¾″ wide×16¾″ long and bent uniquely in 4 places to allow this invention to hang over the top of an interior closet door and to allow for flexibility. This Flexibility is necessary to allow a cat or cats to pull on the plush mouse or cricket or frog or whatever that is attached to the elastic cord hanging from the metal cat toy. Both the elastic cord and the unique bends in the rectangular piece of 16-gauge sheet metal allow for this flexibility giving the cat or cats a moving, bouncing, swinging target to pounce on and grab with their claws or fangs or box with their paws.

### BRIEF DESCRIPTION OF THE SEVERAL VIEWS OF THE DRAWING(S)

FIG. 1 is a very busy image showing everything included in my invention except the plush stuffed hanging mouse, cricket, frog or whatever. Subsequent figures/images will show specific parts of my invention separated out and in more detail.

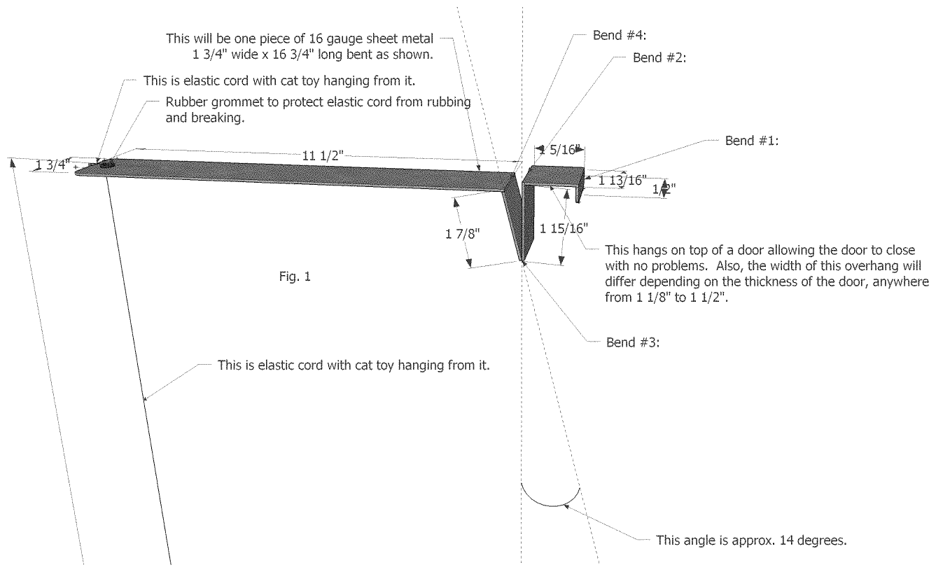

FIG. 2 shows where all 4 of the bends will be made. Bend #1 is a 45-degree bend made ½″ from the end of the 1¾″×16¾″ rectangle. Bend #2 is made 1 5/16″ or 1⅜″ from bend #1 and it is also a 45-degree bend. Bend #3 is made 1 15/16″ or 2″ from Bend #2 and is about a 14-degree bend, and bend #4 is made 11½″ from the opposite end of the 1¾″×16¾″ rectangle or 1⅞″ from bend #3 and is a 85.4-degree bend.

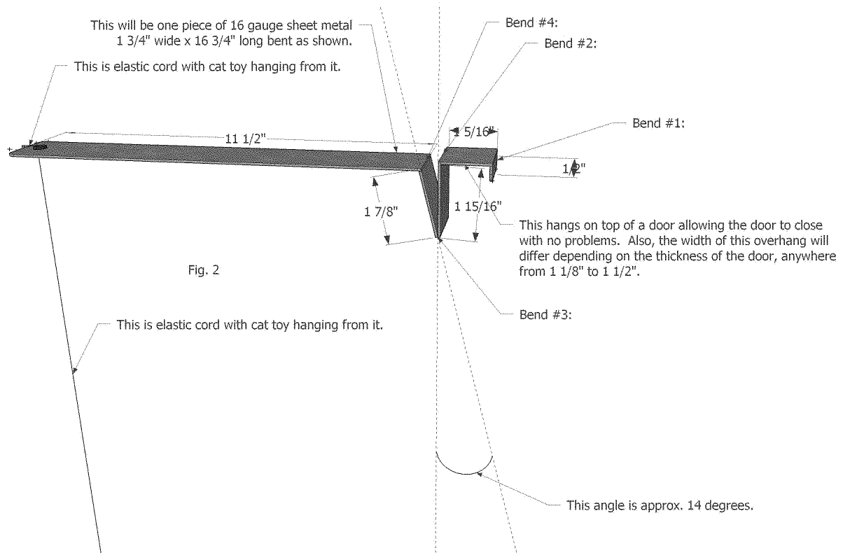

FIG. 3 shows a rubber gromet that will be pushed into a hole that will be drilled into the 1¾″×16¾″ rectangular 16-gauge piece of sheet metal. FIG. 3 also shows that the elastic cord will be tied to the bottom of the gromet and looped under the end of the sheet metal and over the top and down through the hole in the gromet.
FIG. 3 also shows that all corners of the sheet of metal will be rounded and filed leave no sharp corners or edges.

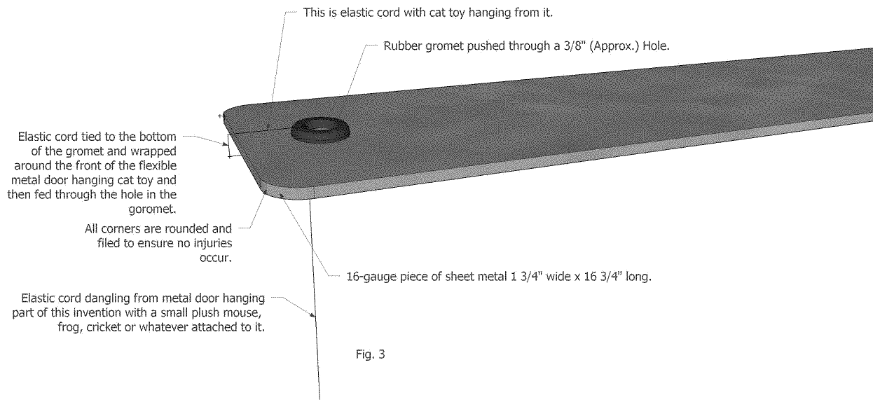

FIG. 4 shows the length of the elastic cord and a very good drawing of a plush mouse [symbol] hanging 5′ under the metal door hanging cat toy. The plush toy whatever it will be, mouse, cricket, shrimp, frog or whatever will have a pinch of catnip sewn into it.

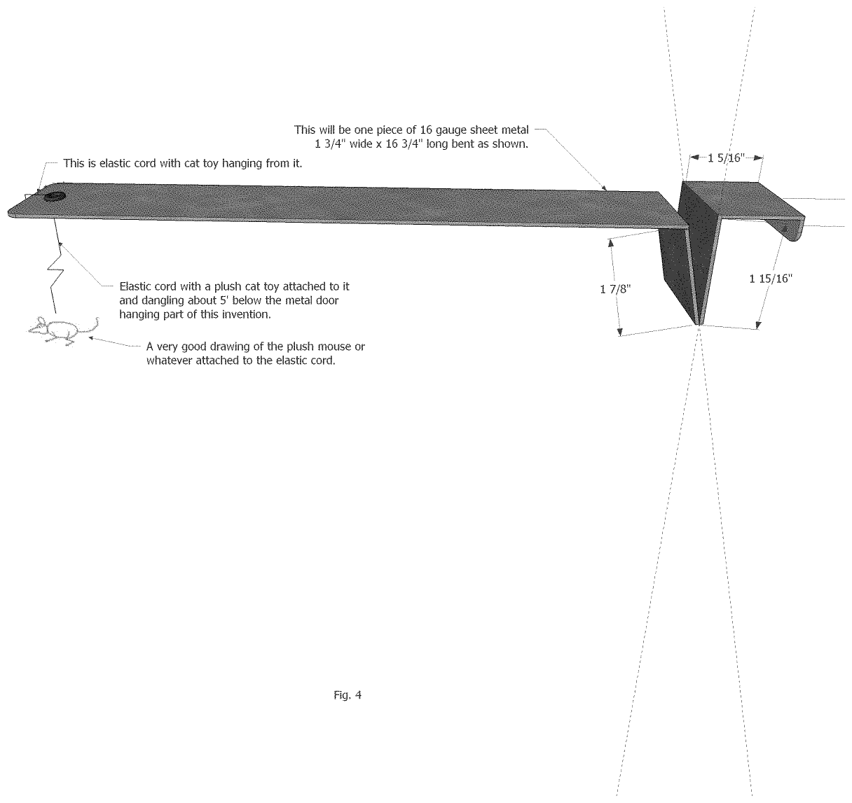

### DETAILED DESCRIPTION OF THE INVENTION

This invention is a metal door hanging cat toy. It will hang over the top of an interior closet door. It includes a small plush mouse, cricket, frog or whatever hanging from a 5′ long elastic cord. This mouse or whatever will have a pinch of catnip sewn into it. This pinch of catnip should make cats want to play with my invention more.

This invention is made out of 16-gauge sheet metal. Each metal door hanging cat toy will be cut into a rectangular shape 1¾″×16¾″ from a larger sheet of 16-gauge sheet metal.

It will have a ⅜″ (approx.) hole drilled in it on one end ½″ from the end and ⅞″ from the side of the rectangular sheet of 16-gauge steel. A rubber gromet will be pressed into the hole.

The 1¾″×16¾″ rectangular plate will be bent 4 times using a pan and box break at (approx.) ½″, 2″, 4″, and 5⅞″ The placement of the bends depend on the thickness of the door. Interior doors range in thickness from 1¼″ to 1½″. Of course, I will bend each door hanging cat toy to the correct dimensions to allow it to fit nicely over the top of the door whatever the thickness. When I start mass producing this invention, if I ever do, I will make sure that it is made in different sizes in order to fit as many thicknesses of doors as possible without causing production costs to rise too high.

This invention will be bent in a unique way to allow it to hang over the top of an interior door without impeding the door's functionality. The bends also allow for flexibility. This flexibility is necessary to allow a cat or cats to grab, bite and pull on the plush mouse, cricket, frog or whatever. The elastic cord that hangs from this invention when it is hanging from the door adds more flexibility and allows the plush mouse or whatever to bounce and swing erratically giving the cat or cats a moving, illusive target.

This invention differs from other door hanging cat toys because it will be made out of 16-gauge sheet metal. This will make my invention last much longer than the plastic models that are out there. In fact, my goal is to sell one to a customer and never have to fix or replace the one they bought. Return customers will be buying a second one to hang over the top of a second door, or they will be buying more of my invention as gifts for friends or relatives.

1. A metal door hanging cat toy designed to allow a cat or multiple cats to bat a stuffed mouse, cricket or lizard or whatever with some catnip sewn in it hanging from an elastic cord that is dangling from the metal door hanging part of this invention around, to grab and pull the stuffed toy with its claws or fangs and pull it or bit it.

2. The metal part of this invention is created from 16-gauge sheet metal and is bent in such a way to allow flexibility. This flexibility allows cats to pull, stretch and let go of the stuffed toy part described in claim 1 so that the stuffed toy bounces around and gives the cat a moving target.

3. Being made out of sheet metal makes this toy unique in that it is more durable and bendable meaning it is almost impossible for a cat or multiple cats to break. A cat or multiple cats might be able to bend it, but the design allows for ample flexibility making this eventuality unlikely.

4. The elastic cord dangling from the sheet metal hanging over the top of the door is the weakest part of this invention. There is a possibility that the cord could snap or that it might be bitten through and severed needing to be replaced with a new elastic cord.

5. The design of this invention requires that there is no slack in the elastic cord hanging from the flexible sheet metal. The stuffed toy will hang off of the floor by at least 5 inches. By hanging the stuffed toy off of the floor, the likelihood that a cat or multiple cats will wrap the elastic cord around itself/themselves thereby causing injury to the cat or cats is unlikely, possible but unlikely.
